(19) United States
(12) Patent Application Publication
(10) Pub. No.: US 2016/0111081 A1
(43) Pub. Date: Apr. 21, 2016

(54) Med Say

(71) Applicant: Leon Moore, JR., Aurora, CO (US)

(72) Inventor: Leon Moore, JR., Aurora, CO (US)

(21) Appl. No.: 14/518,627

(22) Filed: Oct. 20, 2014

(51) Int. Cl. G10L 13/02

(52) U.S. Cl. CPC G10L 13/02

(57) ABSTRACT

After years of mispronouncing medication names and listening to other people struggle with trying to say a medication that they have been on for several years, I was inspired to invent Med Say. Med Say is a useful process that provides the proper pronunciation of brand and generic medication names. Soon I realized that anyone who needs this information should have quick and easy access to having a medication properly pronounced for them from an electronic device such as a smart phone, tablet, computer, etc. Finally a simple process is available that allows for medications to be searched, retrieved, and properly pronounced via an electronic audio file.

Med Say was invented by Certified Pharmacy Technician Leon Moore, Jr. on Feb. 17, 2014. Med Say is a technology process that provides the correct pronunciation of brand and generic prescription and over-the-counter medication names in an audio format that can be clearly heard. The idea is to begin with the creation of a mobile application as well as a software program that will solve the problem of not having access to audio that will provide a proper way of pronouncing medication names. By simply launching the mobile application from a mobile device, or a drug manufacturer's website, the user will be able to hear the correct pronunciation of a medication and or medications that are entered into a search engine by the user. The user will then click or select the Med Say logo or the illustration adjacent to the medication name and the medication will be properly and clearly pronounced for them. Med Say will also provide written information about the medication that is searched such as drug class, indications, drug interactions, and side effects. The software program is an interactive way for students to learn medications by repeating the medication name through a microphone or headset. Instead of using index cards to study from, the Med Say software program gives the user a new, interactive, and fun way to learn medications.

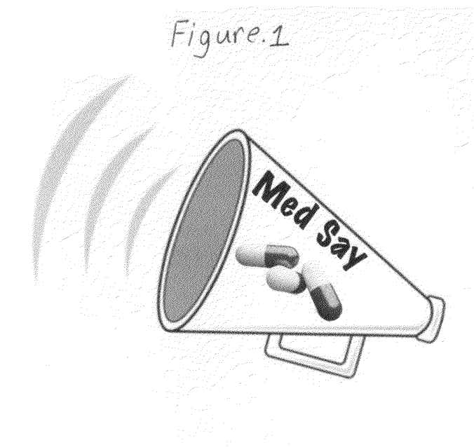

FIG. 1 includes a drawing of the Med Say Logo. It shows a megaphone with the name Med Say displayed above three pills. There are three curved lines coming from the large end of the megaphone.

These represent a medication that is being properly and clearly pronounced. Med Say is not limited to only a mobile application or software program. Med Say technology can be used through other products, too. As a medical professional and Audio and Media Technology college graduate, I realize that Med Say technology will provide an invaluable service to its users.

1. Med Say is an electronic process that provides the correct pronunciation of brand and generic prescription and over-the-counter medication names in an audio format that can be clearly heard through a transducer such as, speakers, headphones, or earphones. The user will be able to hear the correct pronunciation of a medication and or medications that are inputted into a software program website's, or mobile application's search engine by the user. The medication does not have to be spelled correctly. The search engine will yield the correct spelling or list similar medications with similar spellings. In order to hear the medication or medications pronounced correctly, the user will click on or select the Med Say logo or the illustration adjacent to the medication name and the medication will be correctly and clearly pronounced for them each time.
